(19) United States
(12) Patent Application Publication
(10) Pub. No.: US 2016/0246930 A1
(43) Pub. Date: Aug. 25, 2016

(54) SYSTEMS AND METHODS FOR POPULATION TESTS OF INDIVIDUALIZED TREATMENTS

(71) Applicant: SMARTORG, INC., Menlo Park, CA (US)

(72) Inventors: Somik RAHA, Mountain View, CA (US); James E. MATHESON, Edmonds, WA (US)

(73) Assignee: SMARTORG, INC., Menlo Park, CA (US)

(21) Appl. No.: 13/897,122

(22) Filed: May 17, 2013

Related U.S. Application Data
(60) Provisional application No. 61/649,104, filed on May 18, 2012.

(51) Int. Cl. G06F 19/00

(52) U.S. Cl. CPC G06F 19/34

(57) ABSTRACT

There is provided a method of testing, involving a model that is custom-fit to hypotheses in fields of knowledge where treatments are different for different people. In medicine, this would allow the testing of customized medicine approaches as a whole over single medicine trials, and open the gateway to the testing of complementary medicine systems that tend to have a heavy focus on customized medicine. In conventional medicine, this would be the equivalent of bringing in structured systems thinking when designing trials. In advertising, this would allow the testing of a customized theory of change around market behavior.

### CROSS REFERENCE TO RELATED APPLICATIONS

This patent application claims the benefit of Provisional Patent Application Ser. No. 61/649,104, titled “Systems and Methods for Population Tests of Individualized Treatments” filed on May 18, 2012, the contents of which are incorporated herein by reference.

### BACKGROUND OF THE INVENTION

1. Field of the Invention

The present disclosure is generally directed to technology for modeling scientific trials.

2. Description of the Related Art

The fields of medicine and advertising typically rely heavily on statistical hypothesis and inference testing to advance their knowledge. This is usually fraught with problems.

For example, many testing approaches involve statistical hypothesis testing with measures that are unclear and hard to interpret. Moreover, they operate under strong assumptions of finding an effective ingredient of a drug that can help treat a condition. This becomes problematic in testing complementary medicine treatments, which look at whole system effects and not a single drug approach. Moreover, complementary medicine practitioners might prescribe very different medicines to two people with the same condition. The test therefore, tends to be rejected by the practitioner, and its results are not usable to draw meaningful conclusions. Moreover, double-blind randomized trials can create ethical and practical difficulties for researchers. For instance, the insistence of attempting a known inferior method of treatment as a placebo would violate the caregiver's Hippocratic oath, even if the patient has agreed to the trial. Bigger practical difficulties arise when double-blind trials can simply not be designed for holistic medical treatments. For instance, if a holistic treatment involves lifestyle change that is customized for an individual, it is practically impossible to conceive of a way to fool a care provider into prescribing it in the garb of something else. These problems are unaddressed in conventional population trial design.

### SUMMARY OF THE INVENTION

In accordance with one embodiment, there is provided a new method of testing that shifts the focus from testing a treatment on a randomized population to testing the logic that produces a customized treatment for a randomized population at an individual level.

The method involves the use of a model (e.g. Bayesian) to custom-fit systems of logic that produce treatments that are customized for patients. In medicine, this would allow the testing of customized medicine approaches as a whole over single medicine trials, and open the gateway to the testing of complementary medicine systems that tend to have a heavy focus on customized medicine. In conventional medicine, this would be the equivalent of bringing in structured systems thinking when designing trials. In advertising, this would allow the testing of a customized theory of change around market behavior.

In accordance with one embodiment, there is provided a method to custom-fit treatment logic by formulating the therapy and its application using an objective classification structure, using that structure to develop a prior probability distribution on effectiveness for each combination in the structure, collecting data against the structure from clinical observations and obtaining an updated posterior probability distribution to make future clinical decisions.

In accordance with one embodiment, a system and method includes receiving, by a computing device, therapeutic markers that are observed on a patient having a particular condition, using these markers to formulate therapy logic in the form of an objective classification structure that can be applied to the patient for customized treatment to produce outcomes; and providing, by the computing device, the outcomes as feedback to the therapy logic in post-trial learning.

The objective classification structure is modeled as k combinations of observed conditions, n combinations of treatments, and n*k assessments of a chance of a good outcome. The combinations of treatments should include options to not pursue any treatment involved in the mix. The therapy logic is encoded by assessing probability of a good outcome for each combination of therapy and conditions as specified in the objective classification structure. These assessments are made by the community of practitioners to produce a histogram for each combination of therapy and condition, which is then summarized as a continuous prior probability distribution on that combination's outcome to allow for probabilistic updating. In one embodiment, a consensus of knowledge in a professional field is determined when the prior probability distribution is narrow and a misunderstanding or disagreement of members of the professional field is determined when the prior probability distribution is broad. After encoding the prior probability distributions, the model is used to determine the best therapy for any member of the patient population based on the conditions that are met. The therapy offered to the patient may or may not be accepted. The choice of the patient and the subsequent outcome is noted and used to update the probability distribution on the outcome. The updated distribution is the posterior probability distribution and is used in subsequent trials as the new prior probability distribution.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a block diagram describing research process steps, practictioner participation steps and their artifacts produced at the end of each research step in accordance with one embodiment;

FIG. 2 is a block diagram describing a method in accordance with one embodiment;

FIG. 3 is a block diagram describing treatment options in accordance with the example of FIG. 2 in accordance with one embodiment;

FIGS. 4A-4H depict a table in accordance with one embodiment;

FIG. 5 is a simplified block diagram of a computing device that can be used to implement various embodiments of the disclosed technology;

FIG. 6 depicts a block diagram of a shift of the focus from treatment to the logic that produces the treatment in accordance with one embodiment;

FIG. 7 is a block diagram showing a formulation consisting of k combinations of observed conditions, n combinations of treatments, and n*k assessments of the chance of a good outcome in accordance with one embodiment;

FIG. 8 is a block diagram of an embodiment in which 8 combinations of observed conditions are formulated, 8 combinations of treatments, and therefore, 64 assessments of the chance of a good outcome in accordance with one embodiment;

FIG. 9 depicts a histogram showing each member of a group having different assessments in accordance with one embodiment;

FIG. 10 depicts using the histogram mean and variance to obtain a prior probability distribution in accordance with one embodiment;

FIG. 11 shows a prior that looks like a uniform distribution in accordance with one embodiment;

FIG. 12 depicts a histogram that has two modes in accordance with one embodiment; and

FIG. 13 depicts a posterior distribution after updating the prior with the observed data of good outcomes in a sample size of 30 in accordance with one embodiment.

### DETAILED DESCRIPTION

In accordance with one embodiment, there is provided a new method of testing, involving a Bayesian model that is custom-fit to hypotheses in fields of knowledge where treatments are different for different people. In medicine, this would allow the testing of customized medicine approaches as a whole over single medicine trials, and open the gateway to the testing of complementary medicine systems that tend to have a heavy focus on customized medicine. In conventional medicine, this would be the equivalent of bringing in structured systems thinking when designing trials. In advertising, this would allow the testing of a customized theory of change around market behavior.

Many testing approaches involve statistical hypothesis testing with measures that are unclear and hard to interpret. Moreover, they involve a flaw in the design of the experiment—the test being undertaken does not often correspond to an actual theory of change that anyone believes in. For instance, when testing complementary medicine treatments, tests often focus exclusively on efficacy of medicines on conditions. However, complementary medicine practitioners might prescribe very different medicines to two people with the same condition. The test therefore, tends to be rejected by the practitioner, and its results are not usable to draw meaningful conclusions. Moreover, double-blind randomized trials are unethical owing to the need to lie to participants about the treatment they are receiving.

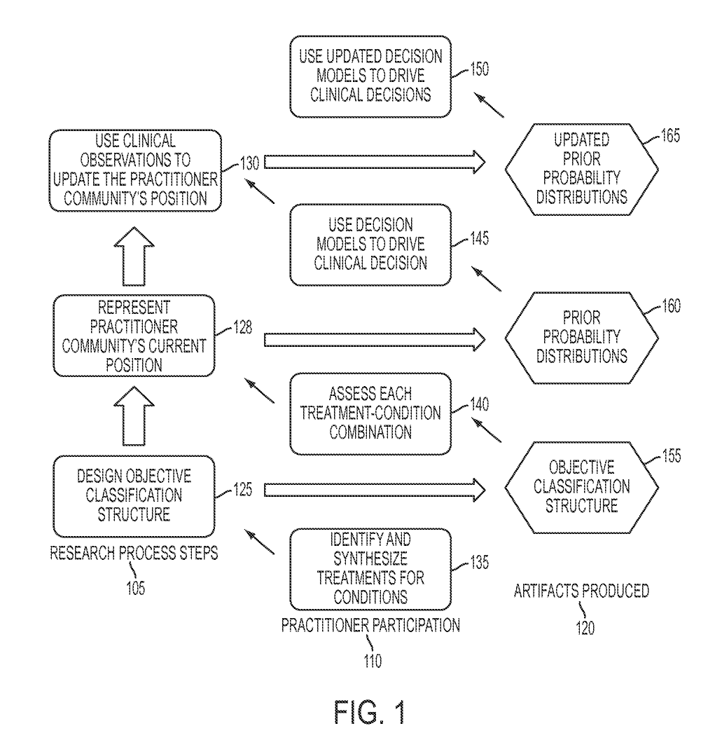

In accordance with one embodiment, there is provided a method that includes designing objective classification structure, collecting data and obtaining a posterior. FIG. 1 is a block diagram of an embodiment describing research process steps 105, practitioner participation steps 110, and the artifacts produced 120 at the end of each research process step. The research process steps 105 are for designing an objective classification structure 125, representing the practitioner community's current position on the effectiveness of therapies described in the objective classification structure 128, and using clinical observations to update the community's position 130, in one embodiment. The practitioner participation steps 110 feed into the research process steps 105 and rely on artifacts 120 produced by the research steps as indicated by the arrows.

Specifically, the practitioner participation steps 110 can include, for example, identify and synthesize treatments for conditions 135, assess each treatment-condition combination 140, use decision models to drive clinical decisions 145, and use updated decision models to drive clinical decisions 150. The artifacts produced 120 can include, for example, objective classification structure 155, prior probability distributions 160, and updated prior probability distributions 165.

Complementary medicine treatments can be quite different for the same disease. Before designing a test, one embodiment includes first replicating the classification logic that determines the course of treatment in an objective manner, to the satisfaction of the community of practice. The artifact produced in this process is termed the “Objective Classification Structure” and is formalized below, where P̂, T̂ and Â are vectors:

T: {Treatments}, A: {Diagnostic Attributes},

p̂(T̂, Â): Fraction of cures assessed by community of practice

In one embodiment, each P̂ is a vector that can be fit into a beta distribution, using the mean and the variance. This distribution can be treated as the community's prior. It will be narrow when there is a lot of agreement and broad when there is a lot of diversity of opinion. When forming the prior probability distribution in one embodiment, care is taken to note the background of those interviewed to verify that they can be considered “experts.”

In one embodiment, a data collection effort on the therapeutic logic under test would involve tapping clinics that are performing treatments, and noting each set of treatments performed for each set of attributes in one embodiment. The outcome measures are also noted.

The outcome measures are then used to perform a binomial update of the beta prior probability distribution of the corresponding therapy and condition combination in one embodiment. For narrow priors, a lot of evidence to the contrary will be needed to get a different posterior. The standard of evidence for broader priors will be lower.

The resulting posterior distributions will form the new prior probability distributions for subsequent trials and will be used to make subsequent treatment decisions.

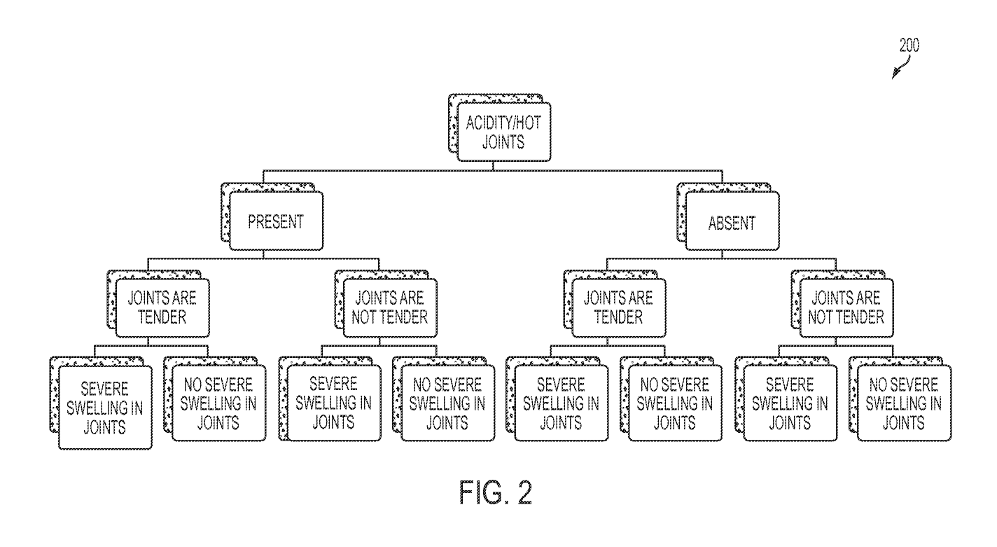

FIG. 2 is a block diagram depicting a method 200 in accordance with one embodiment. For example, FIG. 2 may demonstrate how this protocol can be used to test treatment of Osteo-arthritis in Ayurveda.

Phase 1: Design Objective Classification Structure.

The objective classification structure involves identifying the questions that need to be asked in designing an effective treatment, and the treatment pathways that correspond to the answers.

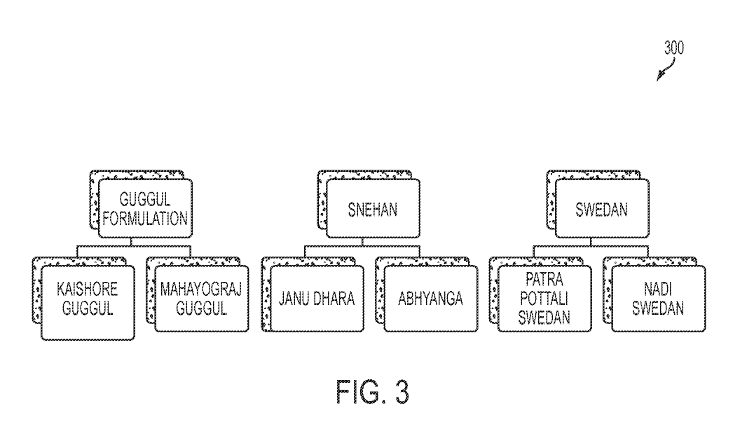

FIG. 3 is a block diagram depicting treatment options 300 in accordance with the example of FIG. 2.

The treatments depicted in FIG. 3 are of the type of Guggul formulation, the type of Snehan and the type of Swedan. Guggul is a form of gum-raisin. Kaishore and Mahayograj are different formulations of Guggul. Snehan is application of oil externally. Janu Dhara is a flow of oil on the knee joint. Abhyanga is an oil massage over the joint. Swedan is fomentation of sweat. Patra Pottali Swedan refers to the use of medicated leaves that are packed in a cloth and exposed to heat, after which they are applied to the joint, causing sweating in the joint. Nadi Swedan involves steaming medicinal herbs (e.g. vacha) and applying that steam to the affected joint.

In one embodiment, a method of population testing involves administering a treatment indicated by the model based on the prior probability distributions, collecting data based on the treatment and administering updating the probability distribution with the outcome. If the patient does not wish to accept the treatment, then the patient's choice and subsequent outcome are recorded and used to update the corresponding treatment and condition combination. Instead of randomized trials, this approach utilizes the observation design approach and thereby avoids the ethical and practical pitfalls of double-blind trials.

Practitioners are asked to provide the probability of getting a good outcome for each treatment and condition combination in one embodiment. In one example, a good outcome is clearly defined as “all symptoms associated with osteo-arthritis have disappeared after 3 months of treatment.”

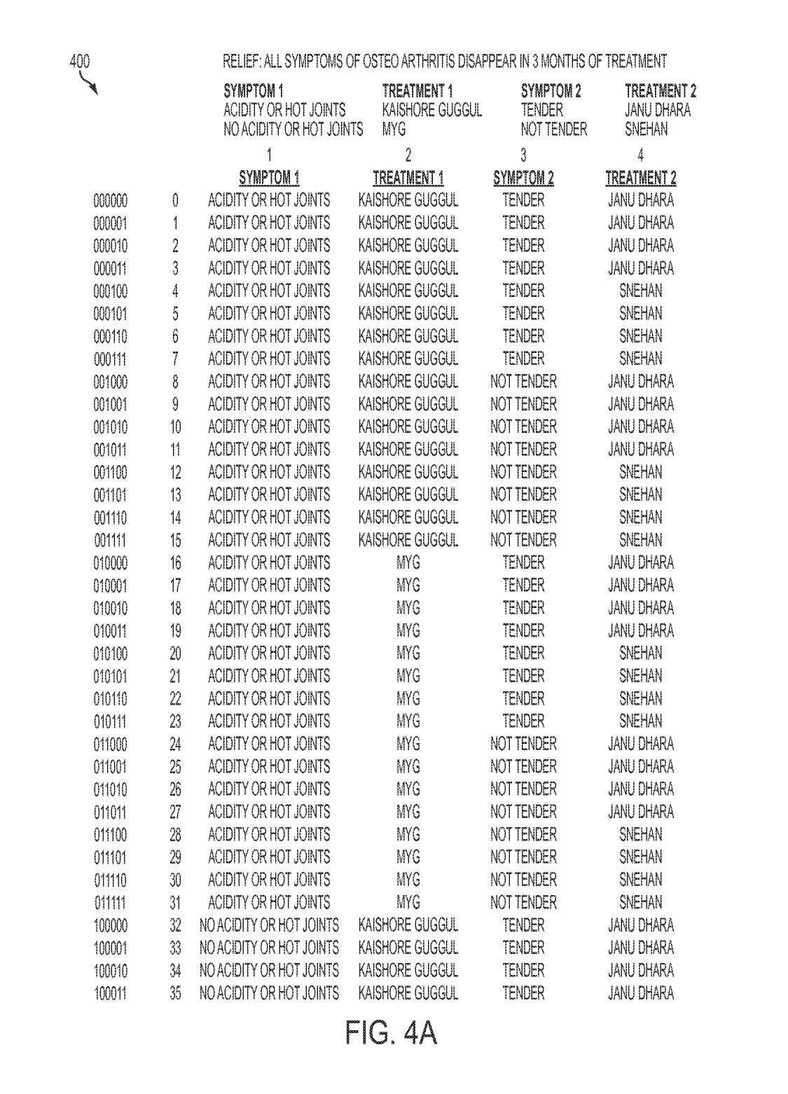

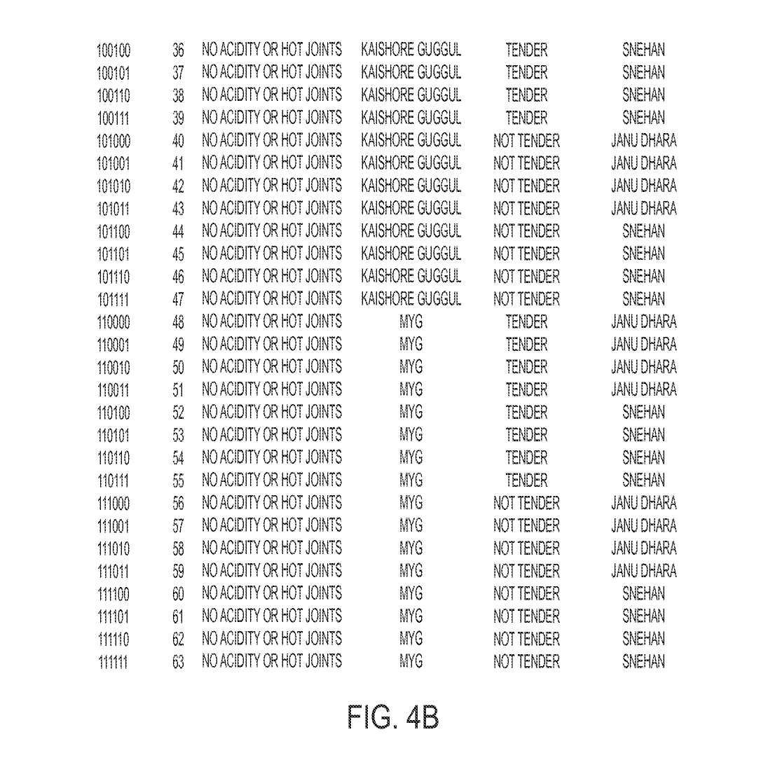

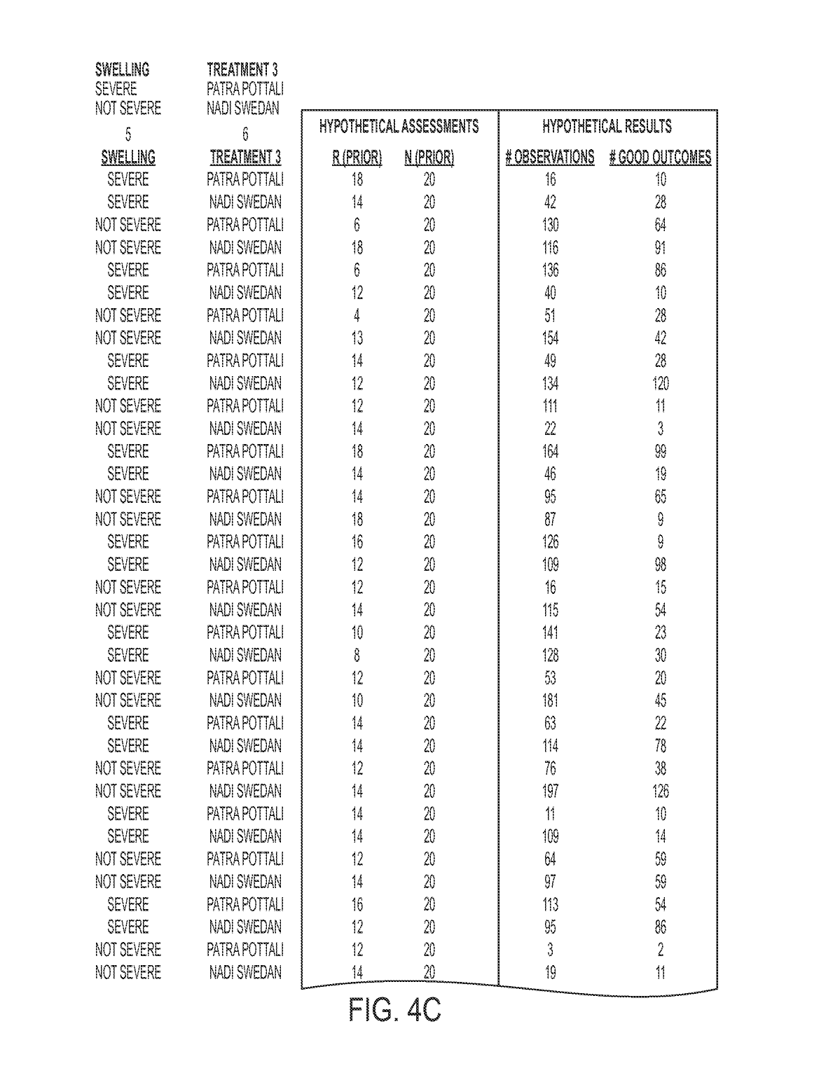

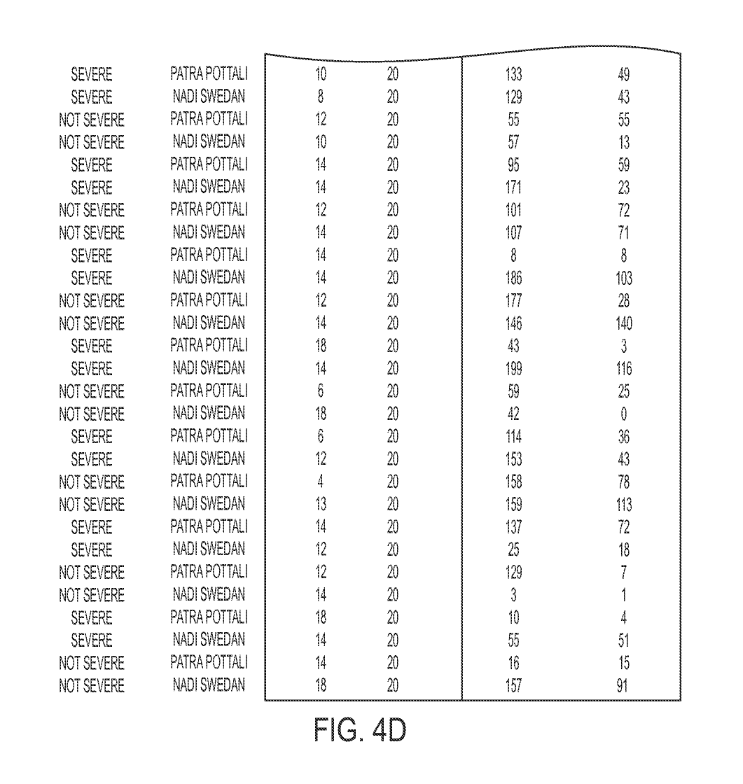

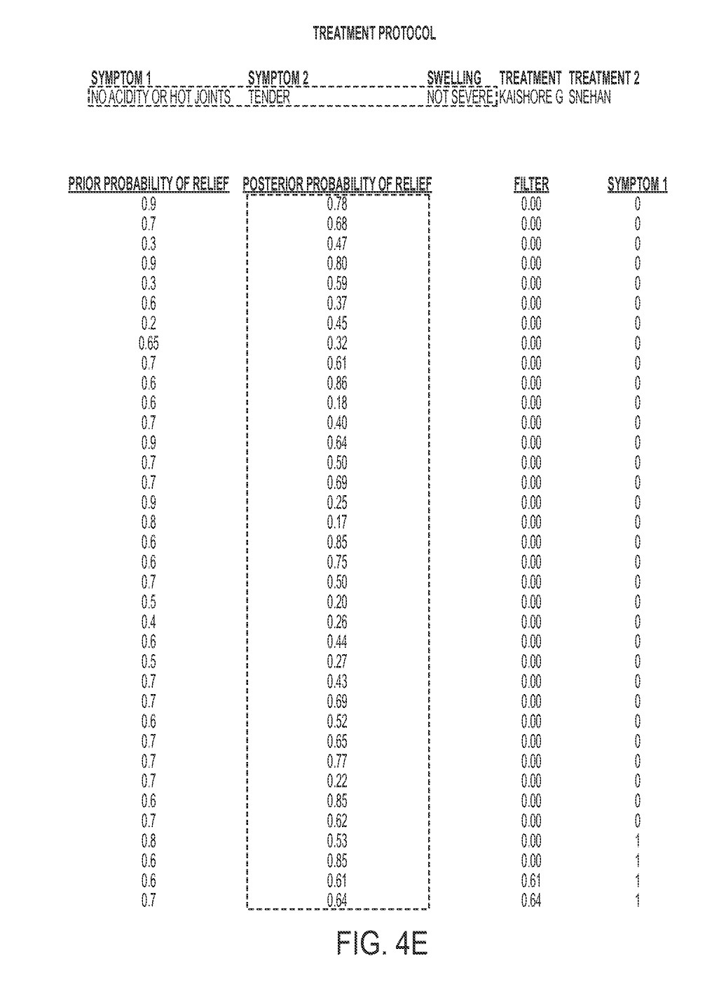

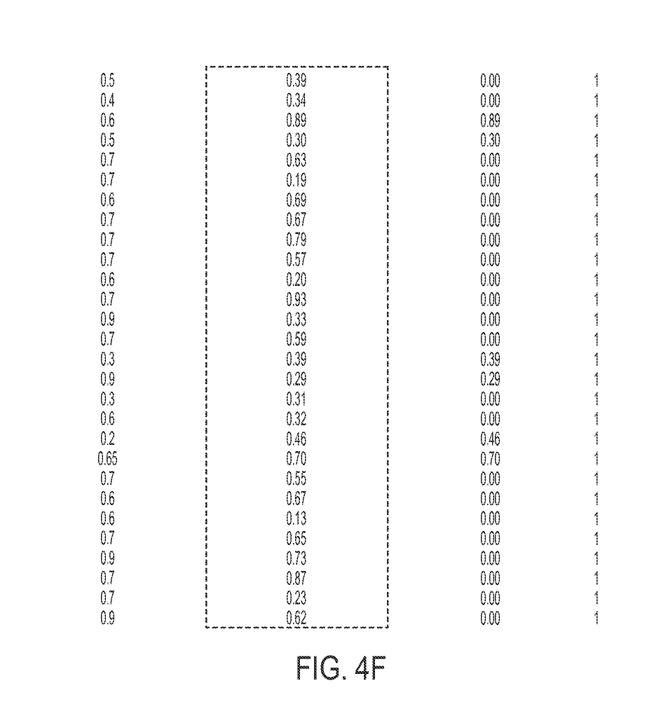

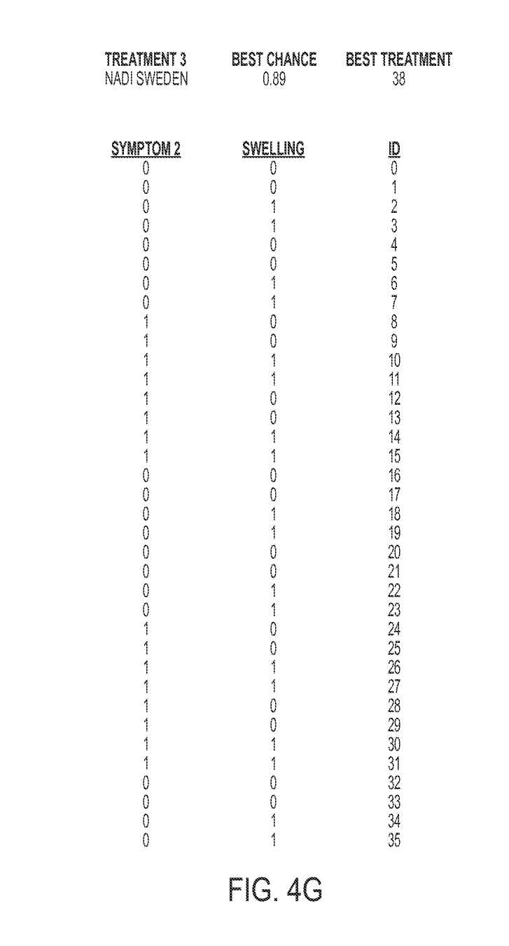

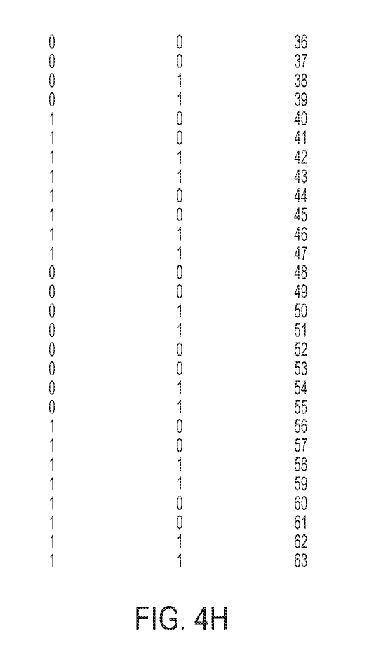

FIGS. 4A-4H depict a spreadsheet 400 in accordance with one embodiment. FIG. 7 shows a decision model that will be used to drive clinical decisions, in one embodiment. For each treatment and condition combination, practitioner doctors will assess the probability of a good outcome. These assessments are not just by one doctor, but by different doctors with an established level of experience (e.g., at least 10 years in the field) in one embodiment. The assessment data from doctors for each treatment condition combination is fit into a beta distribution, in one embodiment. The beta distributions describe where the community converges and diverges in its assessments.

In the example from FIG. 2, data will be collected from Ayurveda clinics participating in the trial. Patients coming for treatment of osteo-arthritis will be treated by the Ayurvedic doctors the way they normally would, and not in a double-blind manner. Participating doctors may also be encouraged to use a decision model (FIGS. 7, 4A-4H show one embodiment that uses the probability of a good outcome as the value measure) that uses the community's prior probability distribution to drive treatment choices. However, this is optional, and what is essential for research is that the doctor record the conditions noted, the treatments suggested to the patient, the actual treatment chosen by the patient and finally, the outcome. The doctor will also record the precise method of the treatment allowing for validation and comparability between different clinics.

For each data point of a good outcome that is obtained in the example, the prior probability distribution for the corresponding set of conditions and treatments will be updated (the beta parameters are incremented) in one embodiment. The result gives us a posterior distribution that may now be used for inference and decision-making.\

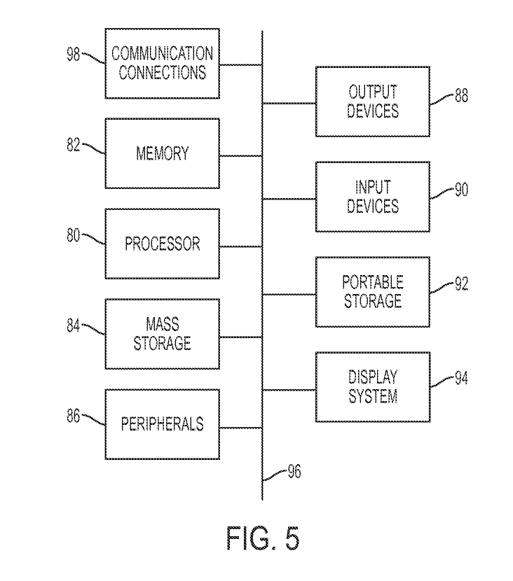

FIG. 5 is a high level block diagram of a computing system which can be used to implement any of the computing devices described herein. The computing system of FIG. 5 includes processor 80, memory 82, mass storage device 84, peripherals 86, output devices 88, input devices 90, portable storage 92, and display system 94. For purposes of simplicity, the components shown in FIG. 5 are depicted as being connected via a single bus 96. However, the components may be connected through one or more data transport means. In one alternative, processor 80 and memory 82 may be connected via a local microprocessor bus, and the mass storage device 84, peripheral device 86, portable storage 92 and display system 94 may be connected via one or more input/output buses.

Processor 80 may contain a single microprocessor, or may contain a plurality of microprocessors for configuring the computer system as a multiprocessor system. Memory 82 stores instructions and data for programming processor 80 to implement the technology described herein. In one embodiment, memory 82 may include banks of dynamic random access memory, high speed cache memory, flash memory, other nonvolatile memory, and/or other storage elements. Mass storage device 84, which may be implemented with a magnetic disc drive or optical disc drive, is a nonvolatile storage device for storing data and code. In one embodiment, mass storage device 84 stores the system software that programs processor 80 to implement the technology described herein. Portable storage device 92 operates in conjunction with a portable nonvolatile storage medium, such as a floppy disc, CD-RW, flash memory card/drive, etc., to input and output data and code to and from the computing system of FIG. 5. In one embodiment, system software for implementing embodiments is stored on such a portable medium, and is input to the computer system via portable storage medium drive 92.

Peripheral devices 86 may include any type of computer support device, such as an input/output interface, to add additional functionality to the computer system. For example, peripheral devices 86 may include one or more network interfaces for connecting the computer system to one or more networks, a modem, a router, a wireless communication device, etc. Input devices 90 provide a portion of a user interface, and may include a keyboard or pointing device (e.g. mouse, track ball, etc.). In order to display textual and graphical information, the computing system of FIG. 5 will (optionally) have an output display system 94, which may include a video card and monitor. Output devices 88 can include speakers, printers, network interfaces, etc. Device 100 may also contain communications connection(s) 112 that allow the device to communicate with other devices via a wired or wireless network. Examples of communications connections include network cards for LAN connections, wireless networking cards, modems, etc. The communication connection(s) can include hardware and/or software that enables communication using such protocols as DNS, TCP/IP, UDP/IP, and HTTP/HTTPS, among others.

The components depicted in the computing system of FIG. 5 are those typically found in computing systems suitable for use with the technology described herein, and are intended to represent a broad category of such computer components that are well known in the art. Many different bus configurations, network platforms, operating systems can be used. The technology described herein is not limited to any particular computing system.

The technology described herein can be implemented using hardware, software, or a combination of both hardware and software. The software used is stored on one or more of the processor readable storage devices described above (e.g., memory 82, mass storage 84 or portable storage 92) to program one or more of the processors to perform the functions described herein. The processor readable storage devices can include non-transitory, tangible computer readable media such as volatile and non-volatile media, removable and non-removable media. Tangible computer readable media may be implemented in any method or technology for storage of information such as computer readable instructions, data structures, program modules or other data. Examples of tangible computer readable media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other non-transitory, tangible medium which can be used to store the desired information and which can be accessed by a computer. In alternative embodiments, some or all of the software can be replaced by dedicated hardware including custom integrated circuits, gate arrays, FPGAs, PLDs, and special purpose computers. In one embodiment, software (stored on a storage device) implementing one or more embodiments is used to program one or more processors. The one or more processors can be in communication with one or more tangible computer readable media/storage devices, peripherals and/or communication interfaces. In alternative embodiments, some or all of the software can be replaced by dedicated hardware including custom integrated circuits, gate arrays, FPGAs, PLDs, and special purpose computers.

In one embodiment, the computing system is used for population testing of individualized treatments. In one embodiment, the computing system includes a formulation module configured to enable formulating of a therapy and its application using an objective classification structure, a distribution module for using the structure to develop a prior probability distribution on effectiveness for each combination in the structure, a data collection module for collecting data against the structure from clinical observations, and an updating module for obtaining an updated posterior probability distribution to make future clinical decisions.

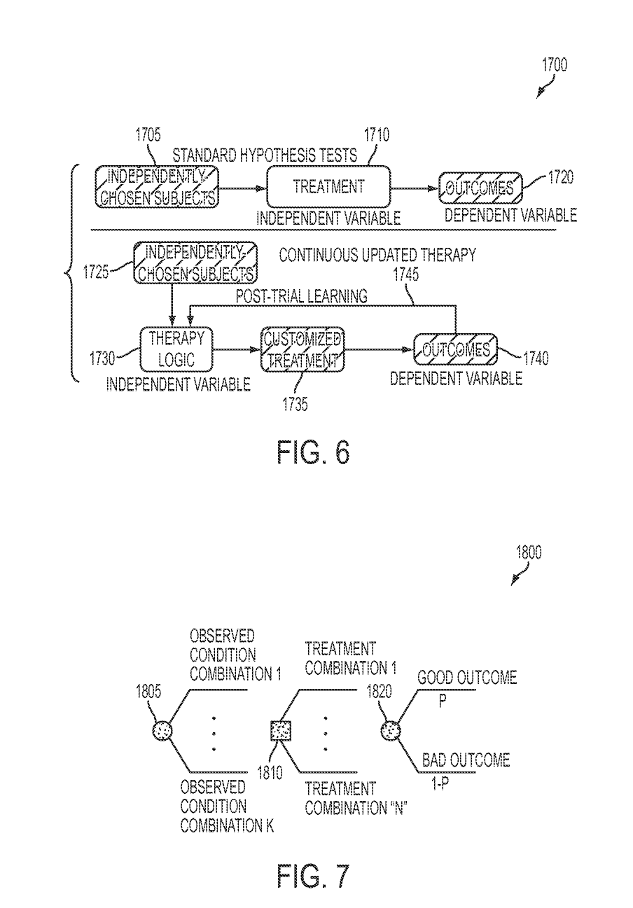

A Continuous Updated Therapy (CUT) method shifts the focus of testing from therapy to logic that produces a custom-fit therapy. This logic should codify the analysis for the condition being treated and result in a therapeutic measure. FIG. 6 depicts a block diagram 1700 of a shift of the focus from treatment to the logic that produces the treatment. In standard hypothesis tests, independently chosen subjects 1705 are subject to treatment 1710 (an independent variable) to produce outcomes (a dependent variable) 1720. In CUT, independently-chosen subjects 1725 are subject to therapy logic 1730 (an independent variable) in an observational design context which produces customized treatment 1735 to produce outcomes 1740 (a dependent variable). These outcomes are provided as feedback to the therapy logic in post-trial learning 1745.

### CUT and Observational Design

The CUT method addresses the feasibility and ethical problems behind double-blind trials by incorporating observation design. Doctors are typically not asked to change their therapeutic approach. Instead, the recommendation of the doctor is recorded, along with the patient's actual choice, followed by the therapeutic outcome.

The steps in the CUT method are described below with the help of the Osteo-arthritis treatment example described above.

### Phase 1: Formulation

### Scope: Limited to Experienced Doctors

A small working group of experienced doctors (e.g., Ayurvedic doctors, or doctors whose treatments are formulated in a holistic manner after examining the current state of imbalance in the patient) will get together and formulate therapy logic for a particular condition (e.g. osteo-arthritis). This logic takes as its input therapeutic markers that are observed on the patient, and produces a custom-fit therapy as an output. An embodiment of the formulation phase has three deliverables:
1. An agreement on the number of treatments and the number of uncertainties that drive those treatment decisions.
2. A clear and agreed-upon definition of a good outcome.
3. An agreement on the necessary qualification needed for the community of practitioners who will develop the prior according to this formulation.
   The purpose of the working group is to check each other's filtering logic and come up with a standardized filter model that the broader (e.g., Ayurvedic) community will consider representative. The working group can aim to outline their collaboration in a paper focused on framing the problem. A good paper would include clear distinctions on the therapies and conditions, extant research on their combinations and a decision tree. FIG. 7 is a block diagram 1800 showing a formulation consisting of k combinations of observed conditions 1805, n combinations of treatments 1810, and n*k assessments of the chance of a good outcome 1820.

As described above, suppose that a group has been obtained to ratify the filter logic for Arthritis treatment. That treatment is typically focused on three decision points:

| | |
|---|---|
| Kaishore Guggul (KG) vs. | KG is a herbal formulation and MYG is a herbo-mineral |
| Maha Yogaraj Guggul (MYG) | formulation. Both tackle bone-degenerative conditions (or |
| | sandhivata) |
| Janu Dhara vs. Snehan | Both are forms of external application of medicated oils. In the |
| | Janu Dhara procedure, warm oil (mixture of Dhanvantar Tailam |
| | and Muruvenna) is dropped in a regulated flow on the affected |
| | joints. The Snehan procedure involves performing an Ayurvedic |
| | massage on the affected part with the oil (Muruvenna and |
| | Kottamchukkadi). |
| Patra Pottali vs. Nadi Swedan | Both are forms of external application of heat. In Patra Pottali, |
| | leaves of certain herbs (dhatura, eranda, arka, nirgundi, shigru) |
| | are wrapped in a cloth, heated and applied on the affected joint. |
| | In Nadi Swedan, steam is given from a decoction of ten herbs |
| | (dashamula). |

Three uncertainties that may be associated with Osteo-arthritis are:

| | |
|---|---|
| Acidity or Hot | Osteo-arthritis is primarily caused by vata (or air and |
| Joints (Presence | ether) affliction, according to Ayurveda. When pitta |
| or Absence) | dosha (fire element) is also associated with osteo- |
| | arthritis, the joints may be warm to the touch, or the |
| | patient may report heat in the joint, or there can be |
| | systemic symptoms of pitta like acidity |
| Tenderness | A tactile test confirms the presence or absence of |
| (Presence | tenderness |
| or Absence) | |
| Severe Swelling | A visual test confirms the presence or absence of |
| or No Swelling | swelling |

The working group may also agree on a definition of a good outcome as “all symptoms of osteo-arthritis have disappeared after three months of treatment.”

In one embodiment, the working group formulates experience criteria to filter doctors who will be invited into the prior development group. For example, only doctors with two decades or more of experience may be invited.

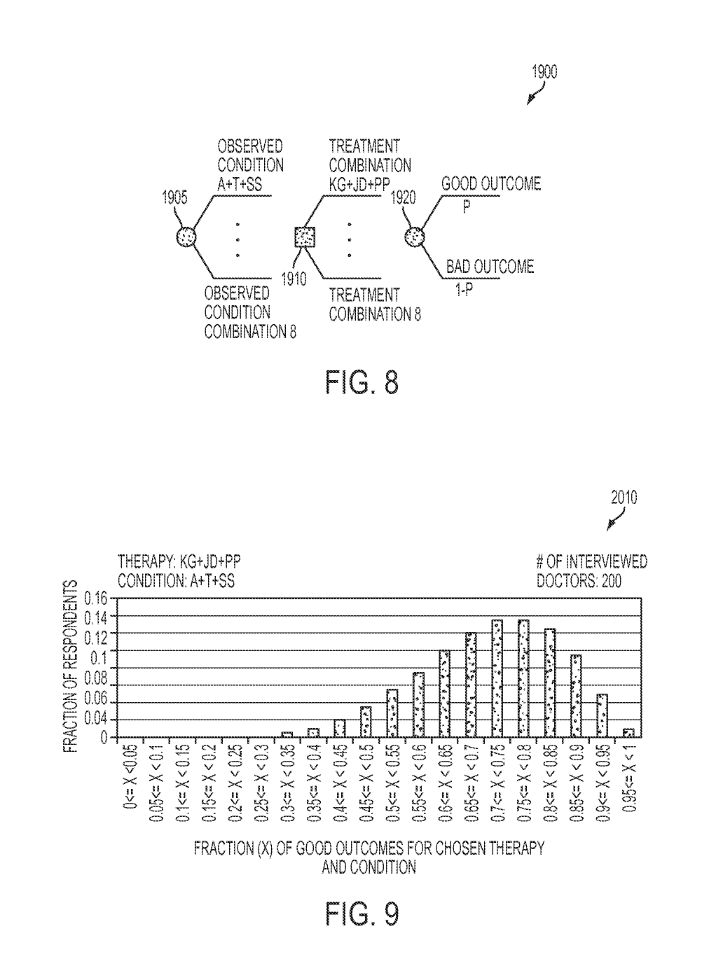

FIG. 8 is a block diagram 1900 of an embodiment in which 8 combinations 1905 of observed conditions are formulated, 8 combinations of treatments 1910, and therefore, 64 assessments 1920 of the chance of a good outcome.

### Phase 2: Development of the Prior

In this phase, a larger prior probability development group composed of doctors at equivalent (and high) capability levels can be tapped and asked to assess the fraction (probability) of good outcomes for each combination of therapeutic choices and uncertainties. In one embodiment, these assessments are performed for each individual in the group, and the distribution of the fractions for a particular combination becomes a prior probability distribution on good outcomes for that combination (there may, however, be an entire spectrum of outcomes, each requiring an assessment). These distributions may play an important role in understanding the standard of (e.g., Ayurvedic) knowledge in the field. A narrow distribution may reveal consensus, while a broad distribution may reveal either misunderstanding or disagreement. Either way, a map of how closely leading Ayurvedic practitioners think would be obtained and our claims can be calibrated before any tests are conducted. The result of this phase may be a paper that illustrates where the (e.g., Ayurvedic) community stands on the therapeutic logic in the form of probability distributions for each combination.

To facilitate updating of these probability distributions when observations are made, the histogram may be converted to a continuous probability distribution. It may be noted that fitting the histogram onto a beta distribution might be the most prudent for two reasons. First, the beta is easy to fit due to its versatility, ranging from a uniform to a Gaussian distribution. Second, it is typically a trivial operation to update the beta distribution by assuming a binomial likelihood function on observations, which implies that every observation is “irrelevant” to other observations given our prior distribution on the fraction of good outcomes for a particular combination of therapy and conditions. Third, the update is further simplified by the fact that the beta distribution is a conjugate distribution, and the posterior distribution is also a beta, which can be obtained by simple addition of the observation counts to the prior distribution's parameters. Some may object to the use of the beta or any distribution from the normal family. Quantile-Parameterized Distributions (QPD) are designed to flexibly fit Cumulative Distribution Functions (CDFs) on quantile assessments. QPDs also have the advantage of being easy to feed into a Monte Carlo simulation. One could use a QPD or any other distribution for that matter that lends itself to a Monte Carlo simulation and combine it with a likelihood function (e.g. binomial) and do a Monte Carlo sampling of the posterior distribution.

In one embodiment, there are 2⁶=64 possible combinations of treatment choices and uncertainty outcomes in this particular formulation of the osteo-arthritis problem. A more real-world example would likely have more therapeutic choices, including the option to not apply a particular treatment. For each possible combination, the prior development group is asked to assess the probability of a good outcome. As shown in FIG. 9, each member of this group can have different assessments, and these differences are plotted as a histogram 2010. A hypothetical histogram 2010 shows what a population of 200 doctors think on the chances of a good outcome for the therapeutic combination KG+JD+PP applied to patients with the condition A+T+SS.

Then, the beta distribution parameters can be calculated from the histogram mean (μ) and variance (σ²) as follows:

$$α = \frac{βμ}{1 - μ} , β = \frac{{μ}^{3} - 2 {μ}^{2} + μ ( {σ}^{2} + 1 ) - {σ}^{2}}{{σ}^{2}}$$

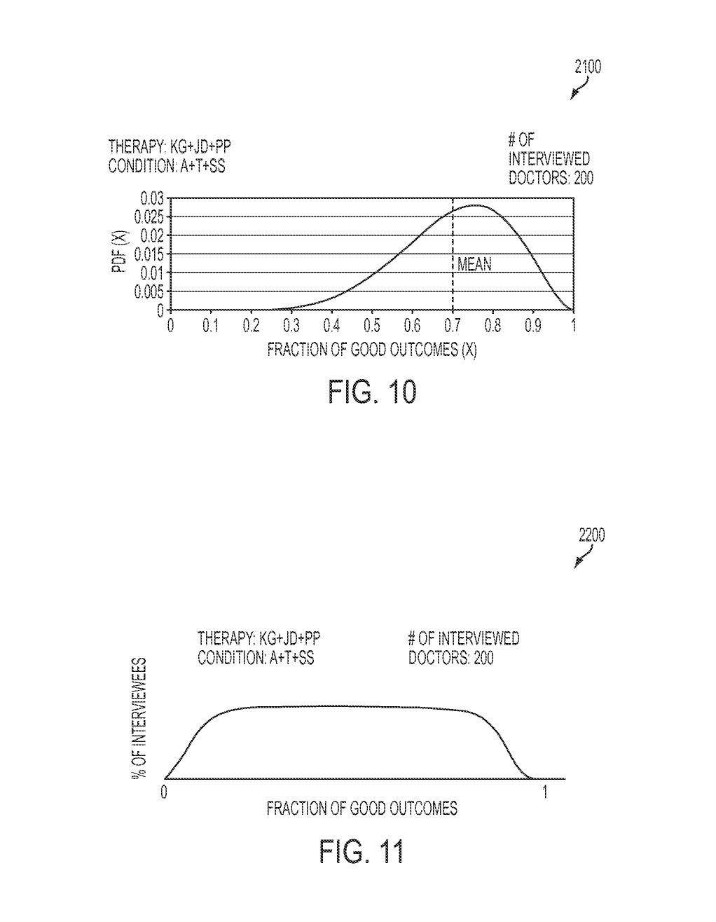

As shown in FIG. 10, this can be used to obtain a prior probability distribution 2100. In one embodiment, 64 priors representing possible combination of therapies and conditions are obtained. As shown in FIG. 11, prior 2200 looks like a uniform distribution.

Such a prior may result in a question as to why there is such a diversity of opinion in the practitioner community. This can result in an investigation as to whether the problem lies in framing this particular alternative combination or if respondent doctors have misunderstood the question.

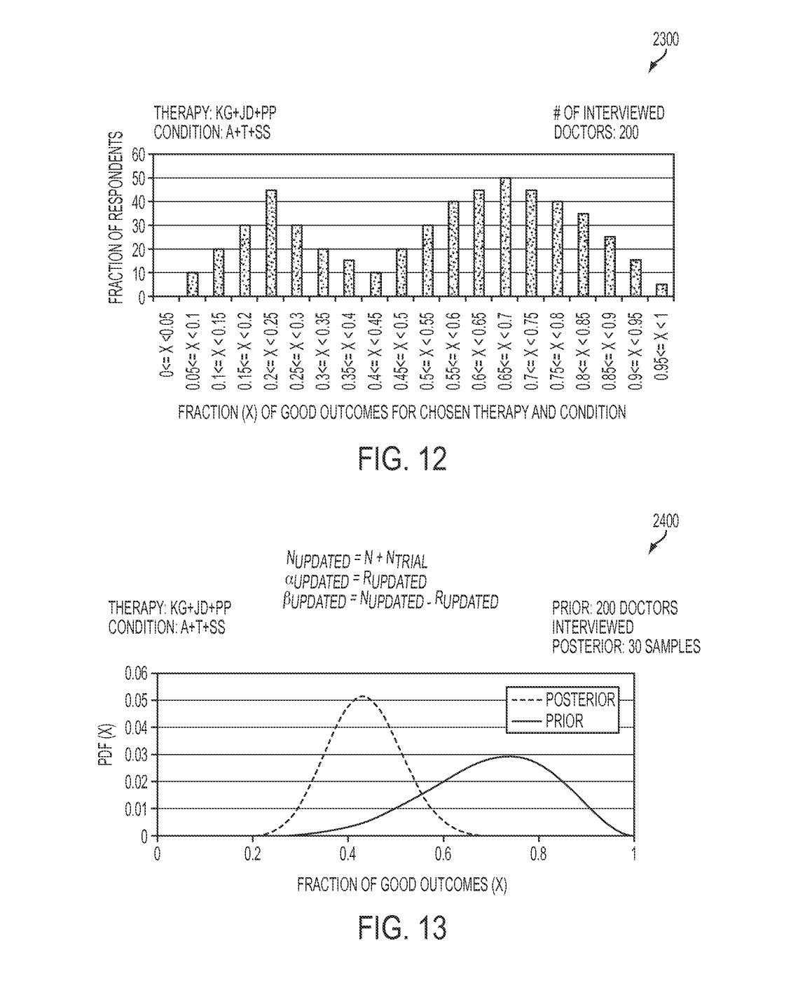

FIG. 12 is a histogram 2300 that has two modes. Histograph 2300 looks like a bi-modal distribution and indicates that there are two opposing points of view. Perhaps there are two sub-schools of thought, and such a result yields a valuable opportunity to bring the two camps together and review why they have differing positions. For the purposes of going into the next phase, there may be two resolutions:
i) The two camps find out that one of them was right, and the other changes their position, resulting in a unimodal distribution
ii) The two camps agree to disagree. In this case,
   a. we may deliberately take the uniform distribution. Or,
   b. we may separate out the two modes into unimodal distributions, and hold two priors, and use both with the evidence that comes out of the next phase
iii) The two camps realize that there is an underlying factor they are treating differently, which should be included as a new uncertainty in the model.
   Thus, the community has opposing points of view which need to be better understood and clarified.

### Phase 3: Conduction of the Test

The strategy of piggy-backing off the regular treatment of doctors without trying to influence it for the purposes of the study has another advantage—such an approach avoids the ethical pitfalls of needing to fool subjects with placebos. It also fundamentally assumes that the final decision-making power around the treatment is in the hands of the patient, who may decide to choose an alternative path than the one the doctor recommends. As described below, the outcome of the actual treatment delivered is of interest, regardless of whether the doctor chose it or the patient chose it.

### Example:

Suppose that, out of 30 patients (nₜᵣᵢₐₗ) with A+T+SS who took the proposed treatment KG+JD+PP, 10 (rₜᵣᵢₐₗ)₁ had a good outcome. The beta distribution parameters are updated as follows:

r=α

n=α+β

r_{updated}=r+rₜᵣᵢₐₗ

n_{updated}=n+nₜᵣᵢₐₗ

α_{updated}=r_{updated}

β_{updated}=n_{updated}−r_{updated}

FIG. 13 depicts the posterior distribution 2400 after updating the prior with the observed data of 10 good outcomes in a sample size of 30. The result shows that the posterior has shifted away to the left, contradicting the initial prior optimism. Its width is indicative of the quantity of data. Usually, the more data, the narrower the posterior distribution. However, the narrower the prior, the more the data is typically needed to cause a substantive shift.
Phase 4: Deployment into Decision-Making

The updated distributions from the previous phase can then be used as the basis for decision systems that produce custom-fit decisions based on the condition of the patient. These could mark the emergence of decision-support systems that are quite different from previous expert system effort. Decision-support systems do not need to mimic the doctor—rather they apply a logical procedure that the doctor would agree with. In this phase, economic factors may also play a role.

### Example:

Continuing with the hypothetical osteo-arthritis example, for a given combination of conditions, those alternatives that have the highest chance of a good outcome can be found. A more sophisticated model may be necessary if some treatment paths are marginally different in outcome probability but vastly different in cost or if some treatment paths have a chance of unwanted side effects.

The foregoing detailed description has been presented for purposes of illustration and description. It is not intended to be exhaustive or to limit the claims to the precise form disclosed. Many modifications and variations are possible in light of the above teaching. The described embodiments were chosen in order to best explain the principles of the claimed subject matter and its practical application to thereby enable others skilled in the art to best utilize it in various embodiments and with various modifications as are suited to the particular use contemplated. It is intended that the scope of the disclosure be defined by the claims appended hereto.

1. A method of formulating an individualized therapy, comprising:
formulating a therapy and a therapy application using an objective classification structure;
using, by a computing device, the objective classification structure to develop a prior probability distribution on effectiveness for each combination in the objective classification structure;
collecting, by the computing device, data against the objective classification structure from one or more clinical observations; and
obtaining, by the computing device, an updated posterior probability distribution to make future clinical decisions.

2. The method of claim 1, wherein the individualized therapy is medical testing and wherein questions and treatment pathways are identified based on administering at least one treatment to at least one patient.

3. The method of claim 1, wherein the individualized therapy is advertising testing and wherein questions and treatment pathways are identified based on testing of a customized theory of change around market behavior.

4. The method of claim 1, further comprising determining a prior of a community.

5.-12. (canceled)

13. A computing device for formulating an individualized therapy comprising:
a formulation module executed by a processor and configured to enable formulating of a therapy and therapy application using an objective classification structure;
a distribution module executed by the processor for using the objective classification structure to develop a prior probability distribution on effectiveness for each combination in the objective classification structure;
a data collection module executed by the processor for collecting data against the objective classification structure from one or more clinical observations; and
an updating module executed by the processor for obtaining an updated posterior probability distribution to make future clinical decisions.

14. The computing device of claim 13, wherein the individualized therapy is medical testing and wherein questions and treatment pathways are identified based on administering at least one treatment to at least one patient.

15. The computing device of claim 13, wherein the individualized therapy is advertising testing and wherein questions and treatment pathways are identified based on testing of a customized theory of change around market behavior.

16-20. (canceled)
